(19) United States
(12) Patent Application Publication
(10) Pub. No.: US 2025/0125733 A1
(43) Pub. Date: Apr. 17, 2025

(54) POWER CONVERTER

(71) Applicant: Murata Manufacturing Co., Ltd., Nagaokakyo-shi (JP)

(72) Inventors: Gang LI, Wuhan (CN); Yuanyuan YI, Wuhan (CN)

(21) Appl. No.: 18/913,046

(22) Filed: Oct. 11, 2024

(30) Foreign Application Priority Data
Oct. 17, 2023 (CN) 202311344553.4

(51) Int. Cl. H02M 3/335; H02M 1/00; H02M 3/00

(52) U.S. Cl. CPC H02M 3/33569; H02M 1/0058; H02M 1/0064; H02M 3/01

(57) ABSTRACT

A power converter includes a first bridge arm and a second bridge arm connected in parallel between a voltage input terminal and a voltage output terminal, a first winding and an inductor connected in series between first and second nodes, a second winding and a third winding connected in series, a third switch connected between the second winding and a ground, and a fourth switch connected between the third winding and the ground. The first bridge arm includes first and second switches connected in series. The second bridge arm includes first and second capacitors connected in series. The first node is on a path connecting the first switch and the second switch, and the second node is on a path connecting the first capacitor and the second capacitor. The first to third windings define a transformer.

### CROSS REFERENCE TO RELATED APPLICATIONS

This application claims the benefit of priority to Chinese Patent Application No. 202311344553.4 filed on Oct. 17, 2023. The entire contents of this application are hereby incorporated herein by reference.

### BACKGROUND OF THE INVENTION

### 1. Field of the Invention

The present disclosure relates to power converters, in particular to non-isolated power converters.

### 2. Description of the Related Art

A power converter is an electronic device that may convert a certain type of current into another type of current. There are DC power conversion and AC power conversion. Most intermediate bus converters (IBCs) provide isolation from input to output by using a transformer, and generally require an inductor for output filtering.

In existing communication systems, an isolated intermediate bus architecture is widely used for safety and power supply efficiency considerations. In such architecture, an input voltage of the system is converted into an intermediate voltage by an isolated intermediate bus converter (IBC), and then converted into a voltage required by a load circuit by a plurality of post-stage non-isolated load point power supplies.

Since a range of the input voltage that the load point power supply at the post-stage of the intermediate bus converter may adapt to is limited, the intermediate bus converter has to control an output voltage within a certain range. In order to adapt to a wider range of the input voltage, when the input voltage is transformed by the intermediate bus converter, an energy storage element such as an inductor has to continuously store and release more energy in the voltage conversion due to the wider range of input voltage, resulting in an increase in the volume and loss of the energy storage element.

However, in many new applications, the power converter has to achieve smaller dimensions, higher efficiency and lower costs. Faced with these requirements, traditional isolated power converters have been severely restricted in their applications due to their disadvantages such as large volume, high energy consumption and low efficiency. In view of this, non-isolated intermediate bus converters have been proposed.

### SUMMARY OF THE INVENTION

A power converter according to an example embodiment of the present disclosure includes a first bridge arm connected between a voltage input terminal and a voltage output terminal, the first bridge arm including a first switch and a second switch connected in series, and being located on a path connecting the voltage input terminal and the voltage output terminal, the first switch being located closer to the voltage input terminal than the second switch, a second bridge arm connected in parallel with the first bridge arm between the voltage input terminal and the voltage output terminal, the second bridge arm including a first capacitor and a second capacitor connected in series, a first winding connected between a first node and a second node, the first node being a node on a path connecting the first switch and the second switch in the first bridge arm, and the second node being a node on a path connecting the first capacitor and the second capacitor C2 in the second bridge arm, an inductor connected in series with the first winding between the first node and the second node, a second winding and a third winding configured such that an opposite-polarity terminal of the second winding is connected to a common-polarity terminal of the third winding, and the first winding, the second winding and the third winding define a transformer by taking the first winding as a primary side, a third switch connected between a common-polarity terminal of the second winding and a ground, and a fourth switch connected between an opposite-polarity terminal of the third winding and the ground.

In an example, a first control signal to control the first switch to be turned on or off is synchronized with a third control signal to control the third switch to be turned on or off, and a second control signal to control the second switch to be turned on or off is synchronized with a fourth control signal to control the fourth switch to be turned on or off. A phase of each of the first control signal and the third control signal differs from a phase of each of the second control signal and the fourth control signal is 180 degrees.

In an example, a capacitance of the first capacitor is equal to a capacitance of the second capacitor.

In an example, each of the first switch, the second switch, the third switch and the fourth switch is controlled to have a turn-on duty cycle of 50% without considering dead zone.

In an example, the inductor includes a circuit parasitic inductance.

In an example, a resonant frequency of a resonant circuit including the first capacitor, the second capacitor and the inductor is equal to an operating frequency of the power converter.

In an example, a number of turns of the second winding is equal to a number of turns of the third winding. A number of turns of the first winding is an integer multiple of the number of turns of the second winding, or the number of turns of the first winding is an integer multiple of half of the number of turns of the second winding.

A power converter involved in another example embodiment of the present disclosure includes a first bridge arm connected between a voltage input terminal and a voltage output terminal, the first bridge arm including a first switch and a second switch connected in series, and being located on a path connecting the voltage input terminal and the voltage output terminal, the first switch being located on a side of the path closer to the voltage input terminal than the second switch, a second bridge arm connected in parallel with the first bridge arm between the voltage input terminal and the voltage output terminal, the second bridge arm including a first capacitor and a second capacitor connected in series, a first winding connected between a first node and a second node, the first node being a node on a path connecting the first switch and the second switch in the first bridge arm, and the second node being a node on a path connecting the first capacitor and the second capacitor in the second bridge arm, an inductor connected in series with the first winding between the first node and the second node, a third bridge arm including a third switch and a fourth switch connected in series, the third bridge being connected to the first bridge arm at a third node, a side of the third bridge arm opposite to the third node being connected to a ground, and the third switch being closer to the third node than the fourth switch, a fourth bridge arm including a fifth switch and a sixth switch connected in series between a fourth node and the ground, the fourth node being a node on a path connecting the third node and the voltage output terminal, and the fifth switch being closer to the fourth node than the sixth switch, a second winding connected between a fifth node and a sixth node, the fifth node being a node on a path connecting the third switch and the fourth switch in the third bridge arm, and the sixth node being a node on a path connecting the fifth switch and the sixth switch in the fourth bridge arm.

In an example, a first control signal to control the first switch to be turned on or off, a third control signal to control the third switch to be turned on or off, and a sixth control signal to control the sixth switch to be turned on or off are synchronized. A second control signal to control the second switch to be turned on or off, a fourth control signal to control the fourth switch to be turned on or off, and a fifth control signal to control the fifth switch to be turned on or off are synchronized. A phase difference between each of the first control signal, the third control signal and the sixth control signal and each of the second control signal, the fourth control signal and the fifth control signal is 180 degrees.

In an example, a capacitance of the first capacitor is equal to a capacitance of the second capacitor.

In an example, each of the first switch, the second switch, the third switch, the fourth switch, the fifth switch and the sixth switch is controlled to have a turn-on duty cycle of 50% without considering dead zone.

In an example, the inductor includes a circuit parasitic inductance.

In an example, a resonant frequency of a resonant circuit including the first capacitor, the second capacitor and the inductor is equal to an operating frequency of the power converter.

In an example, a number of turns of the first winding is an integer multiple of a number of turns of the second winding, or the number of turns of the first winding is an integer multiple of half of the number of turns of the second winding.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a circuit diagram illustrating a main portion of a power converter according to a first example embodiment of the present disclosure.

FIG. 2 is a schematic diagram illustrating a current flow direction of the power converter in a first mode according to the first example embodiment of the present disclosure.

FIG. 3 is a schematic diagram illustrating a current flow direction of the power converter in a second mode according to the first example embodiment of the present disclosure.

FIG. 4 is a timing diagram illustrating control signals in the power converter according to the first example embodiment of the present disclosure.

FIG. 5 is a circuit diagram illustrating a main portion of a power converter according to a second example embodiment of the present disclosure.

FIG. 6 is a schematic diagram illustrating a current flow direction in a first mode of the power converter according to the second example embodiment of the present disclosure.

FIG. 7 is a schematic diagram illustrating a current flow direction in a second mode of the power converter according to the second example embodiment of the present disclosure.

FIG. 8 is a timing diagram illustrating control signals in the power converter according to the second example embodiment of the present disclosure.

### DETAILED DESCRIPTION OF THE EXAMPLE EMBODIMENTS

Hereinafter, example embodiments of the present disclosure will be described in detail below with reference to the accompanying drawings. In each figure, the same or corresponding constituent elements are labeled with the same reference numerals and repeated explanations are omitted. In addition, various example embodiments of the present disclosure are exemplary and may be partially replaced or combined with structures between different example embodiments.

It should be pointed out that the example embodiments of the following description are used to help understand the present disclosure, rather than to provide a limited explanation of the present disclosure.

In addition, in the following description, terms “first”, “second”, etc. are only to distinguish one component, parameter, or numerical value from other components, parameters, or numerical values, and the present disclosure is not limited by these terms. In addition, in the following description, the so-called “connection” includes not only direct connection, but also indirect connection through other components, and further includes non-direct contact methods such as electromagnetic field coupling.

According to example embodiments of the present disclosure, power converters capable of achieving soft switching are provided.

### First Example Embodiment

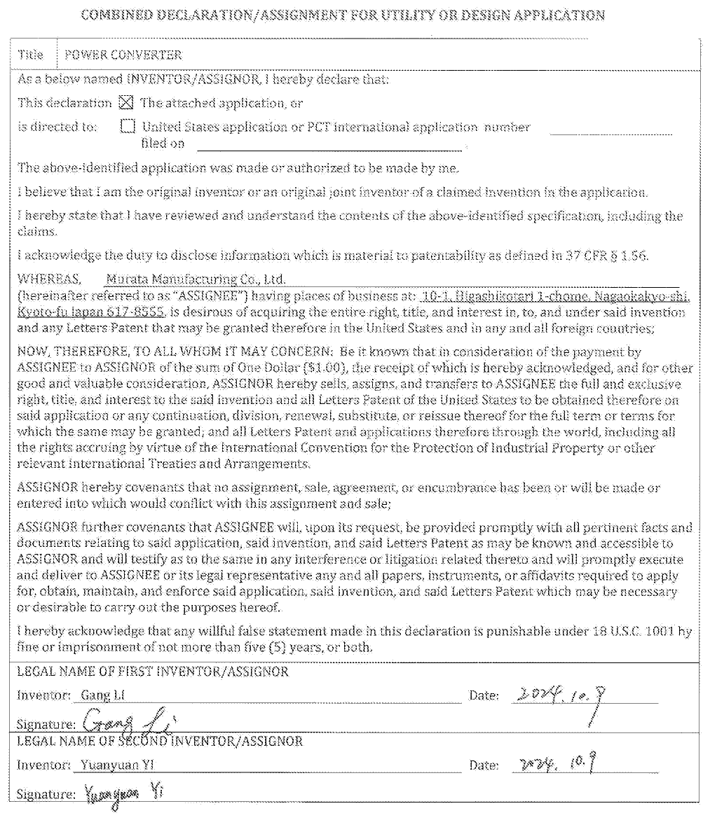

FIG. 1 is a circuit diagram illustrating a main portion of a power converter according to a first example embodiment of the present disclosure.

As shown in FIG. 1, in the first example embodiment, the power converter 1 includes a first switch Q1, a second switch Q2, a third switch Q3, a fourth switch Q4, a first capacitor C1, a second capacitor C2, an inductor L1, a first winding P1, a second winding S1 and a third winding S2. The first switch Q1, the second switch Q2, the third switch Q3 and the fourth switch Q4 may be various transistors.

The first switch Q1 and the second switch Q2 are connected in series between a voltage input terminal VIN and a voltage output terminal VOUT to define a first bridge arm. In the first example embodiment, the first switch Q1 is located closer to the voltage input terminal VIN than the second switch Q2 on a path connecting the voltage input terminal VIN and the voltage output terminal VOUT. An input voltage Vin is provided from the voltage input terminal VIN, and an output voltage Vout is extracted between the voltage output terminal VOUT and the ground. A load may be connected between the voltage output terminal and the ground. The first switch Q1 may be turned on or off according to a first control signal Vg1. The second switch Q2 may be turned on or off according to a second control signal Vg2.

The first capacitor C1 and the second capacitor C2 are connected in series to define a second bridge arm. The second bridge arm is connected between the voltage input terminal VIN and the voltage output terminal VOUT, and the second bridge arm is connected in parallel with the first bridge arm. Preferably, a capacitance of the first capacitor C1 is equal to a capacitance of the second capacitor C2. In this case, each of the capacitance of the first capacitor C1 and the capacitance of the second capacitor C2 is set to be Cr/2.

The first winding P1 and the inductor L1 are connected in series between a node N1 and a node N2. The node N1 is a node on a path connecting the first switch Q1 and the second switch Q2 in the first bridge arm, and the node N2 is a node on a path connecting the first capacitor C1 and the second capacitor C2 in the second bridge arm. The inductor L1 may include an independent inductor element, but is not limited to this. For example, the inductor L1 may also include a circuit parasitic inductance. An inductance of the inductor L1 is set to be Lr. A resonant circuit includes the first capacitor C1, the second capacitor C2 and the inductor L1. A resonant frequency of the resonant circuit is set to be fr.

The second winding S1 and the third winding S2 are connected in series. More specifically, an opposite-polarity terminal of the second winding S1 is connected to a common-polarity terminal of the third winding S2. The first winding P1, the second winding S1 and the third winding S2 define a transformer, where the first winding P1 is a primary side.

The third switch Q3 is connected between a common-polarity terminal of the second winding S1 and the ground, and the third switch Q3 is turned on or off according to a third control signal Vg3. The fourth switch Q4 is connected between an opposite-polarity terminal of the third winding S2 and the ground, and the fourth switch Q4 is turned on or off according to a fourth control signal Vg4.

In the power converter 1 of the first example embodiment, it is preferred that a number of turns of the second winding S1 is equal to a number of turns of the third winding S2. In this case, a number of turns of the first winding P1 is set to be n1, and each of the number of turns of the second winding S1 and the number of turns of the second winding S2 is set to be n2.

The power converter 1 of the first example embodiment may also include a resistor R1 and a third capacitor C3. The resistor R1 and the third capacitor C3 are connected in parallel between a node N3 and the ground. The node N3 is a node on a path connecting the second winding S1 and the second winding S2. The node N3 is connected to the voltage output terminal VOUT. Therefore, it may be said that a parallel circuit of the resistor R1 and the third capacitor C3 is connected between the voltage output terminal VOUT and the ground.

According to this structure, in the power converter 1 of the first example embodiment, the output voltage Vout and the input voltage Vin satisfy a relationship shown in an equation (1):

$$Vout = Vin * n 2 / ( 2 * n 1 + n 2 ) \qquad equation ( 1 )$$

That is to say, a ratio of the output voltage Vout to the input voltage Vin satisfies a relationship shown in an equation (2):

$$Vout / Vin = n 2 / ( 2 * n 1 + n 2 ) \qquad equation ( 2 )$$

According to the equation (2) above, it may be seen that in the power converter 1 of the first example embodiment, a transformation ratio between the output voltage Vout and the input voltage Vin may be changed by adjusting n1 and n2.

Specifically, when n1 is an integer multiple of n2, a voltage transformation of a fixed odd ratio may be reliably achieved between the input voltage Vin and the output voltage Vout. For example, when n1=n2, a fixed transformation ratio of 1:3 may be reliably achieved. For another example, when n1=2n2, a fixed transformation ratio of 1:5 may be reliably achieved.

Furthermore, when n1 is an odd multiple of half of n2, a transformation ratio of a fixed even ratio may be reliably achieved between the input voltage Vin and the output voltage Vout. For example, when n1=0.5n2, a fixed transformation ratio of 1:2 may be reliably achieved. For another example, when n1=1.5n2, a fixed transformation ratio of 1:4 may be reliably achieved.

Hereinafter, operating modes of the power converter 1 of the first example embodiment will be described with reference to FIG. 2 to FIG. 4.

FIG. 2 is a schematic diagram illustrating a current flow direction of the power converter in a first mode according to the first example embodiment of the present disclosure. FIG. 3 is a schematic diagram illustrating a current flow direction of the power converter in a second mode according to the first example embodiment of the present disclosure. FIG. 4 is a timing diagram illustrating control signals in the power converter according to the first example embodiment of the present disclosure.

With reference to FIG. 4, a first control signal Vg1 is synchronized with a third control signal Vg3, and a second control signal Vg2 is synchronized with a fourth control signal Vg4. A phase difference between each of the first control signal Vg1 and the third control signal Vg3 and each of the second control signal Vg2 and the fourth control signal Vg4 is 180 degrees. That is, when the first control signal Vg1 and the third control signal Vg3 are at high level, the second control signal Vg2 and the fourth control signal Vg4 are at low level, and vice versa. Hereinafter, the first switch Q1 and the third switch Q3 may be collectively referred to as a “first group of switches”, and the second switch Q2 and the fourth switch Q4 may be collectively referred to as a “second group of switches”.

With reference to FIG. 4, in a period of t1 to t2, the first control signal Vg1 and the third control signal Vg3 are at high level, the first switch Q1 and the third switch Q3 are turned on, the second control signal Vg2 and the fourth control signal Vg4 are at low level, and the second switch Q2 and the fourth switch Q4 are turned off. In this case, a current flowing through the power converter 1 is shown by a dashed arrow and a dotted arrow in FIG. 2. In this case, the operating state is a “first mode”.

In a period of t3 to t4, the first control signal Vg1 and the third control signal Vg3 are at low level, the first switch Q1 and the third switch Q3 are turned off, the second control signal Vg2 and the fourth control signal Vg4 are at high level, and the second switch Q2 and the fourth switch Q4 are turned on. In this case, the current flowing through the power converter 1 is shown by a dashed arrow and a dotted arrow in FIG. 3. In this case, the operating state is a “second mode”.

In a period of t2 to t3, the control signals Vg1 to Vg4 are at low level, and the switches Q1 to Q4 are turned off. In other words, the period of t2 to t3 is a dead zone, during which the power converter does not operate. By setting the dead zone, the power converter is protected so as to smoothly transition from the first mode to the second mode. Similarly, there is also a dead zone of t4 to t5 after the operating state of the second mode ends. Without considering dead zone, a duty cycle of each of the first control signal Vg1 and the third control signal Vg3 is preferably 50%. Similarly, without considering dead zone, a duty cycle of each of the second control signal Vg2 and the fourth control signal Vg4 is preferably 50%.

In other words, each of the first group of switches (including the first switch Q1 and the third switch Q3) and the second group of switches (including the second switch Q2 and the fourth switch Q4) is preferably controlled to have a turn-on duty cycle of 50% without considering dead zone.

As mentioned above, it is preferred that the capacitance of the first capacitor C1 is equal to the capacitance of the second capacitor C2, both of which are Cr/2. In addition, the inductance of the inductor L1 is Lr. In this case, the resonant frequency fr of the resonant circuit including the inductor L1, the first capacitor C1 and the second capacitor C2 is determined by an equation (3).

$$fr = 1 / [ 2 π \sqrt{( Lr * Cr )} ] \qquad equation ( 3 )$$

An operating frequency of the power converter 1 is set to be fs. In this case, it is preferred that fs=fr.

Therefore, in the first mode, the first switch Q1 and the third switch Q3 may achieve soft switching. Similarly, in the second mode, the second switch Q2 and the fourth switch Q4 may achieve soft switching.

In addition, when the capacitance of the first capacitor C1 is equal to the capacitance of the second capacitor C2, which means that a midpoint of a resonant capacitor including the first capacitor C1 and the second capacitor C2 is connected to the resonant inductor L1 and the primary side of the transformer. In this case, an input ripple current may be reduced.

### Second Example Embodiment

FIG. 5 is a circuit diagram illustrating a main portion of a power converter according to a second example embodiment of the present disclosure.

As shown in FIG. 5, the power converter 1A of the second example embodiment is different from the power converter 1 of the first example embodiment in that the full-wave rectification circuit of the third switch Q3 and the fourth switch Q4 is changed into a full-bridge rectification circuit. Specifically, in the power converter 1A of the second example embodiment, the third winding S2 is omitted. In addition, the power converter 1A further includes a fifth switch Q5 and a sixth switch Q6.

In the power converter 1A, the third switch Q3 and the fourth switch Q4 are connected in series to define a third bridge arm. The third bridge arm is connected to the first bridge arm at a node N4, and a side of the third bridge arm opposite to the node N4 is connected to the ground. The third switch Q3 is located closer to the node N4 than the fourth switch Q4 on a path connecting the node N4 to the ground. The fifth switch Q5 and the sixth switch Q6 are connected in series between a node N5 and the ground to define a fourth bridge arm. The node N5 is a node on a path connecting the node N4 to the voltage output terminal VOUT. The fifth switch Q5 is located closer to node N5 than the sixth switch Q6 on a path connecting the node N5 to the ground. The fifth switch Q5 is turned on or off according to a fifth control signal Vg5. The sixth switch Q6 is turned on or off according to a sixth control signal Vg6. According to the timing diagram of the first control signal Vg1 to the sixth control signal Vg6 in FIG. 8, it may be seen that the first control signal Vg1, the third control signal Vg3 and the sixth control signal Vg6 are synchronized, and the second control signal Vg2, the fourth control signal Vg4 and the fifth control signal Vg5 are synchronized. A phase difference between each of the first control signal Vg1, the third control signal Vg3 and the sixth control signal Vg6 and each of the second control signal Vg2, the fourth control signal Vg4 and the fifth control signal Vg5 is 180 degrees.

In the second example embodiment, the first group of switches include a first switch Q1, a third switch Q3 and a sixth switch Q6. The second group of switches include a second switch Q2, a fourth switch Q4 and a fifth switch Q5.

The second winding S1 is connected between a node N6 and a node N7, where the node N6 is a node on a path connecting the third switch Q3 and the fourth switch Q4 in the third bridge arm, and the node N7 is a node on a path connecting the fifth switch Q5 and the sixth switch Q6 in the fourth bridge arm. The first winding P1 and the second winding S1 define a transformer, where the first winding P1 is a primary side and the second winding S1 is a secondary side.

The power converter 1A of the second example embodiment may also include a resistor R1 and a third capacitor C3. The resistor R1 and the third capacitor C3 are connected in parallel between the voltage output terminal VOUT and the ground.

According to the power converter 1A with the above structure, when a number of turns of the first winding P1 is set to n1 and a number of turns of the second winding S1 is set to n2, a ratio of the output voltage Vout to the input voltage Vin satisfies a relationship shown in an equation (4) as follow:

$$Vout / Vin = n 2 / ( 2 * n 1 + n 2 ) \qquad equation ( 4 )$$

It may be seen that in the power converter 1A of the second example embodiment, similarly to the power converter 1 of the first example embodiment, a transformation ratio between the output voltage Vout and the input voltage Vin may be changed by adjusting n1 and n2.

Moreover, when n1 is an integer multiple of n2, a voltage transformation of a fixed odd ratio may be reliably achieved between the input voltage Vin and the output voltage Vout. Furthermore, when n1 is an odd multiple of half of n2, a voltage transformation of a fixed even ratio may be reliably achieved between the input voltage Vin and the output voltage Vout.

Hereinafter, operating modes of the power converter 1A of the second example embodiment will be described with reference to FIG. 6 to FIG. 8.

FIG. 6 is a schematic diagram illustrating a current flow direction of the power converter in a first mode according to the second example embodiment of the present disclosure. FIG. 7 is a schematic diagram illustrating a current flow direction of the power converter in a second mode according to the second example embodiment of the present disclosure. FIG. 8 is a timing diagram illustrating control signals in the power converter according to the second example embodiment of the present disclosure.

With reference to FIG. 8, in a period of t1 to t2, the first control signal Vg1, the third control signal Vg3 and the sixth control signal Vg6 are at high level, the first switch Q1, the third switch Q3, and the sixth switch Q6 are turned on, the second control signal Vg2, the fourth control signal Vg4 and the fifth control signal Vg5 are at low level, and the second switch Q2, the fourth switch Q4 and the fifth switch Q5 are turned off. In this case, a current flowing through the power converter 1A is shown by a dashed arrow and a dotted arrow in FIG. 6. In this case, the operating state is a “first mode” of the power converter 1A.

In a period of t3 to t4, the first control signal Vg1, the third control signal Vg3 and the sixth control signal Vg6 are at low level, the first switch Q1, the third switch Q3 and the sixth switch Q6 are turned off, the second control signal Vg2, the fourth control signal Vg4 and the fifth control signal Vg5 are at high level, and the second switch Q2, the fourth switch Q4 and the fifth switch Q5 are turned off. In this case, the current flowing through the power converter 1A is shown by a dashed arrow and a dotted arrow in FIG. 7. In this case, the operating state is a “second mode” of the power converter 1A.

In the second example embodiment, similarly to the first example embodiment, a dead zone of t2 to t3 is set between the period of t1 to t2 and the period of t3 to t4, and a dead zone of t4 to t5 is set after the period of t3 to t4. In the second example embodiment, a duty cycle of each of the first control signal Vg1, the third control signal Vg3 and the sixth control signal Vg6 is preferably 50%. Similarly, a duty cycle of each of the second control signal Vg2, the fourth control signal Vg4 and the fifth control signal Vg5 is preferably 50%.

In other words, in the second example embodiment, each of the first group of switches (including the first switch Q1, the third switch Q3 and the sixth switch Q6) and the second group of switches (including the second switch Q2, the fourth switch Q4 and the fifth switch Q5) is preferably controlled to have a turn-on duty cycle of 50% without considering dead zone.

In the second example embodiment, it is preferred that the capacitance of the first capacitor C1 is equal to the capacitance of the second capacitor C2. In addition, the resonant frequency of the resonant circuit including the inductor L1, the first capacitor C1 and the second capacitor C2 is equal to the operating frequency of the power converter 1A, so that the first switch Q1, the third switch Q3 and the sixth switch Q6 may achieve soft switching in the first mode. Similarly, the second switch Q2, the fourth switch Q4 and the sixth switch Q6 may achieve soft switching in the second mode.

In addition, when the capacitance of the first capacitor C1 is equal to the capacitance of the second capacitor C2, an input ripple current may be reduced.

The power converters of the present disclosure are described in detail above in conjunction with example embodiments, but the present disclosure is not limited to this. Those skilled in the art may make various modifications, substitutions, and changes to example embodiments of the present disclosure without departing from the main purpose of the present disclosure. Other example embodiments achieved by combining any of the elements, features, characteristics, etc., of the above example embodiments, example embodiments obtained by implementing various deformations thought of by those skilled in the art to the above example embodiments within the scope of the main purpose of the present disclosure, and various devices having the power converters according to example embodiments of the present disclosure built therein are included in the present disclosure.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A power converter, comprising:
a first bridge arm connected between a voltage input terminal and a voltage output terminal, the first bridge arm including a first switch and a second switch connected in series, and being located on a path connecting the voltage input terminal and the voltage output terminal, the first switch being located closer to the voltage input terminal than the second switch;
a second bridge arm connected in parallel with the first bridge arm between the voltage input terminal and the voltage output terminal, the second bridge arm including a first capacitor and a second capacitor connected in series;
a first winding connected between a first node and a second node, the first node being a node on a path connecting the first switch and the second switch in the first bridge arm, and the second node being a node on a path connecting the first capacitor and the second capacitor C2 in the second bridge arm;
an inductor connected in series with the first winding between the first node and the second node;
a second winding and a third winding configured such that an opposite-polarity terminal of the second winding is connected to a common-polarity terminal of the third winding, and the first winding, the second winding and the third winding define a transformer by taking the first winding as a primary side;
a third switch connected between a common-polarity terminal of the second winding and a ground; and
a fourth switch connected between an opposite-polarity terminal of the third winding and the ground.

2. The power converter of claim 1, wherein
a first control signal to control the first switch to be turned on or off is synchronized with a third control signal to control the third switch to be turned on or off;
a second control signal to control the second switch to be turned on or off is synchronized with a fourth control signal to control the fourth switch to be turned on or off; and
a phase difference between each of the first control signal and the third control signal and each of the second control signal and the fourth control signal is 180 degrees.

3. The power converter of claim 1, wherein a capacitance of the first capacitor is equal to a capacitance of the second capacitor.

4. The power converter of claim 1, wherein each of the first switch, the second switch, the third switch and the fourth switch is controlled to have a turn-on duty cycle of 50% without considering dead zone.

5. The power converter of claim 1, wherein the inductor includes a circuit parasitic inductance.

6. The power converter of claim 1, wherein a resonant frequency of a resonant circuit including the first capacitor, the second capacitor and the inductor is equal to an operating frequency of the power converter.

7. The power converter of claim 1, wherein
a number of turns of the second winding is equal to a number of turns of the third winding; and
a number of turns of the first winding is an integer multiple of the number of turns of the second winding, or the number of turns of the first winding is an integer multiple of half of the number of turns of the second winding.

8. A power converter, comprising:
a first bridge arm connected between a voltage input terminal and a voltage output terminal, the first bridge arm including a first switch and a second switch connected in series, and being located on a path connecting the voltage input terminal and the voltage output terminal, the first switch being located on a side of the path closer to the voltage input terminal than the second switch;
a second bridge arm connected in parallel with the first bridge arm between the voltage input terminal and the voltage output terminal, the second bridge arm including a first capacitor and a second capacitor connected in series;
a first winding connected between a first node and a second node, the first node being a node on a path connecting the first switch and the second switch in the first bridge arm, and the second node being a node on a path connecting the first capacitor and the second capacitor in the second bridge arm;
an inductor connected in series with the first winding between the first node and the second node;
a third bridge arm including a third switch and a fourth switch connected in series, the third bridge being connected to the first bridge arm at a third node, a side of the third bridge arm opposite to the third node being connected to a ground, and the third switch being closer to the third node than the fourth switch;
a fourth bridge arm including a fifth switch and a sixth switch connected in series between a fourth node and the ground, the fourth node being a node on a path connecting the third node and the voltage output terminal, and the fifth switch being closer to the fourth node than the sixth switch;
a second winding connected between a fifth node and a sixth node, the fifth node being a node on a path connecting the third switch and the fourth switch in the third bridge arm, and the sixth node being a node on a path connecting the fifth switch and the sixth switch in the fourth bridge arm.

9. The power converter of claim 8, wherein
a first control signal to control the first switch to be turned on or off, a third control signal to control the third switch to be turned on or off, and a sixth control signal to control the sixth switch to be turned on or off are synchronized;
a second control signal to control the second switch to be turned on or off, a fourth control signal to control the fourth switch to be turned on or off, and a fifth control signal to control the fifth switch be turned on or turned off are synchronized; and
a phase difference between each of the first control signal, the third control signal and the sixth control signal and each of the second control signal, the fourth control signal and the fifth control signal is 180 degrees.

10. The power converter of claim 8, wherein a capacitance of the first capacitor is equal to a capacitance of the second capacitor.

11. The power converter of claim 8, wherein each of the first switch, the second switch, the third switch, the fourth switch, the fifth switch and the sixth switch is controlled to have a turn-on duty cycle of 50% without considering dead zone.

12. The power converter of claim 8, wherein the inductor includes a circuit parasitic inductance.

13. The power converter of claim 8, wherein a resonant frequency of a resonant circuit including the first capacitor, the second capacitor and the inductor is equal to an operating frequency of the power converter.

14. The power converter of claim 8, wherein a number of turns of the first winding is an integer multiple of a number of turns of the second winding, or the number of turns of the first winding is an integer multiple of half of the number of turns of the second winding.
